(19) United States
(12) Patent Application Publication
(10) Pub. No.: US 2016/0257176 A1
(43) Pub. Date: Sep. 8, 2016

(54) DEVICE AND METHOD FOR CONNECTING A FIRST AND A SECOND UNIT OF AN ARTICULATED VEHICLE

(71) Applicant: P.E.I. PROTEZIONI ELABORAZIONI INDUSTRIALI S.R.L., Calderara Di Reno (IT)

(72) Inventors: Giorgio TABELLINI, Sasso Marconi (IT); Michele BENEDETTI, Bologna (IT)

(21) Appl. No.: 15/028,853

(22) PCT Filed: Oct. 14, 2014
(86) PCT No.: PCT/IB2014/065301

§ 371 Date: Apr. 12, 2016

(30) Foreign Application Priority Data
Oct. 15, 2013 (IT) BO2013A000562

(51) Int. Cl. B60D 1/30

(52) U.S. Cl. CPC B60D 1/30; B60D 5/00

(57) ABSTRACT

A device for connecting a first unit and a second unit of an articulated vehicle, including means for connecting the first and second unit, configured for allowing a movement on a horizontal plane of the first and second unit, for varying the relative position on the horizontal plane between the first and second unit, and a movement on a vertical plane of the first and second unit, for varying the relative position on the vertical plane between the first and second unit, the connecting means being at least in part made from composite material reinforced with fibre.

### TECHNICAL FIELD

This invention relates to a device and a method for connecting a first and a second unit of an articulated vehicle.

### BACKGROUND ART

The invention applies in particular, but without limiting the invention, to the technical sector of articulated buses, where there are a plurality of technical prior art solutions to allow the connection together of two units of the articulated bus, respectively the front unit and the rear unit.

As is known, in order to allow the circulation on the road, the connection between the two units must have predetermined features and functions.

More specifically, the two units must be connected to each other in such a way as to allow the relative movement on a horizontal plane of the two units, so as to safely deal with bends in the road and changes of direction.

Moreover, to allow the vehicle to deal with any irregularities of the road surface (for example, roughness, bumps, holes, etc.), and any change in gradient of the road surface, is necessary to allow the relative movement of the two units in a vertical plane.

In the sector in question, there are various prior art connecting devices.

An example of these devices is known from prior art documents U.S. Pat. No. 8,282,306, U.S. Pat. No. 6,296,414, U.S. Pat. No. 7,338,060.

It should be noted that these devices are extremely heavy and, as such, determine, in use, an additional energy consumption of the vehicle, and they reduce the useful life of the shock absorbing system of the vehicle.

A strongly felt need in the sector in question is that of a connecting system which is particularly lightweight and, at the same time, provides the necessary functions, as well as being able to guarantee high standards of safety.

The need to reduce the weight of the connecting device is not easily compatible with the need to guarantee high standards of operational reliability of the connection.

It should be noted that the connection between the two units is, in effect, particularly critical and important for the safety of the occupants of the vehicle since any failure of the connection may cause a mechanical separation between the two units, thereby resulting in serious injury and damage to persons and property.

### DISCLOSURE OF THE INVENTION

The aim of this invention is therefore to provide a device and a method for connecting together two units of an articulated vehicle which is able to overcome the above-mentioned drawbacks and to satisfy the above mentioned need.

Yet another aim of this invention is to provide a device and a method for connecting together two units of an articulated vehicle which is particularly is light and able to guarantee high standards of safety.

Yet another aim of this invention is to provide a device and a method for connecting together two units of an articulated vehicle which allows the life of the vehicle to be extended and to reduce the energy consumption.

These aims are achieved by device for connecting a first unit and a second unit of an articulated vehicle, comprising means for connecting the first and second unit, configured for allowing a movement on a horizontal plane of the first and second unit, for varying the relative position on the horizontal plane between the first and second unit, and a movement on a vertical plane of the first and second unit, for varying the relative position on the vertical plane between the first and second unit, the device being characterised in that the connecting means are at least in part made from composite material reinforced with fibre.

### BRIEF DESCRIPTION OF DRAWINGS

The technical features of the invention, with reference to the above aims, are clearly described in the claims below and its advantages are apparent from the detailed description which follows, with reference to the accompanying drawings which illustrate a non-limiting example embodiment of the invention and in which:

FIG. 1 shows a schematic view of a first embodiment of the connecting device according to the invention;

FIGS. 2 and 3 show a schematic view of a second embodiment of the connecting device according to the invention in two respective configurations.

### DETAILED DESCRIPTION OF PREFERRED EMBODIMENTS OF THE INVENTION

With reference to the accompanying drawings, the numeral 1 denotes a device for connecting a first unit 2A and a second unit 2B of an articulated vehicle.

It should be noted that the connecting device 1 also defines a pulling device of the unit located at the rear or a pushing device of the unit located at the front.

It should be noted that, if the device (motor) for moving the vehicle is positioned on board the rear unit, the rear unit in the normal operation of the vehicle applies, through the device 1 itself, a pushing action on the front unit.

Thus, in this case, the device 1 transmits a pushing force from the rear unit to the front unit.

On the other hand, it should be noted that, if the device (motor) for moving the vehicle is positioned on board the front unit, the front unit in the normal operation of the vehicle applies a pulling action on the front unit.

For this reason, in this case, the device 1 transmits a pulling force from the front unit to the rear unit.

For this reason, more generally, the device 1 is a connecting and pulling device or a connecting and pushing device.

Preferably, the articulated vehicle is a vehicle for transporting passengers (yet more preferably an articulated bus).

According to the invention, the device 1 comprises means 3 for connecting the first and second unit 2A, 2B, configured for allowing a movement on a horizontal plane of the first and second unit 2A, 2B, for varying the relative position, in particular the angle of inclination, on the horizontal plane between the first and second unit 2A, 2B, and a movement on a vertical plane of the first and second unit 2A, 2B, for varying the relative position, in particular the angle of inclination, on the vertical plane between the first and second unit 2A, 2B.

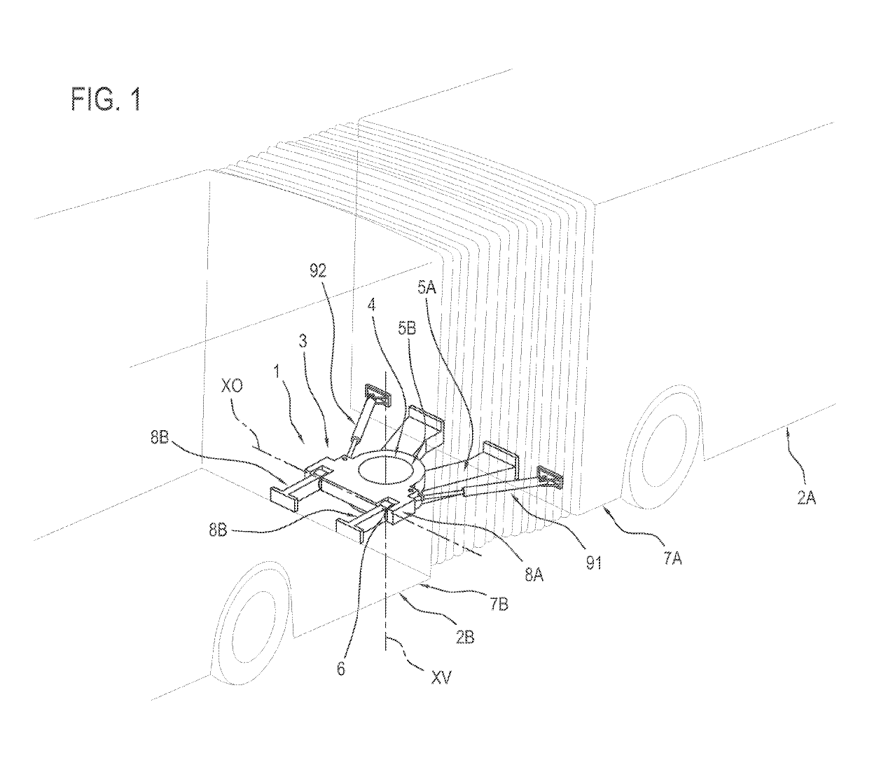

Preferably, but without restricting the scope of the invention, the movement on a horizontal plane is a rotation about a vertical axis XV (FIG. 1).

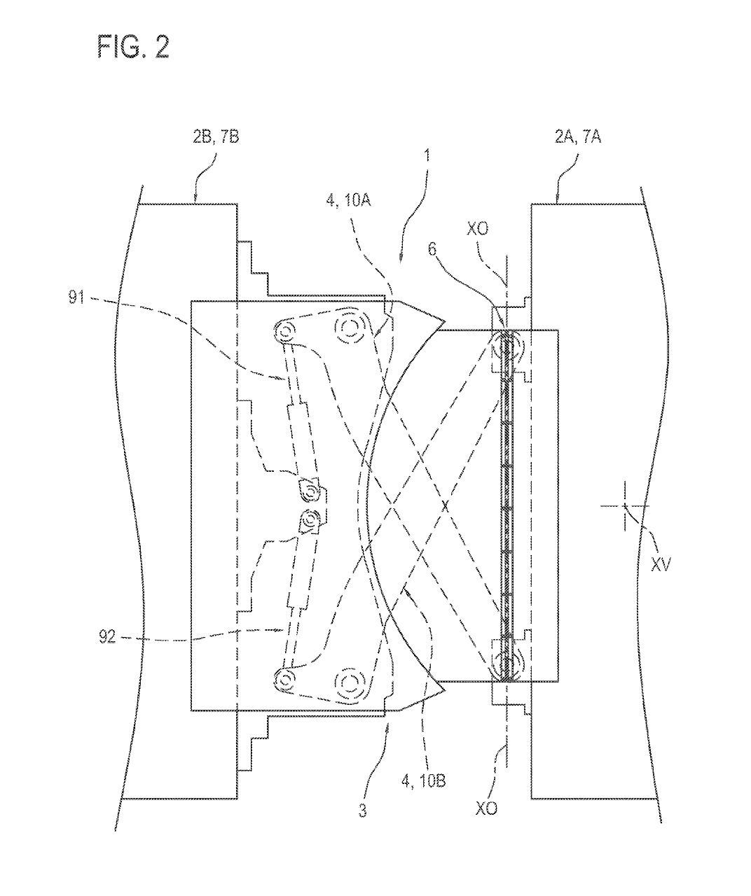

Alternatively, the movement on a horizontal plane is a roto-translation (FIG. 2), that is, a combined rotation and translation movement.

Preferably, but without restricting the scope of the invention, the movement on a vertical plane is a rotation about a horizontal axis XO.

Alternatively, the movement on a vertical plane is a roto-translation, that is, a combined rotation and translation movement.

According to the invention, it should be noted that the connecting means 3 are at least in part made from composite material reinforced with fibre.

More specifically, preferably, the portion of the connecting means 3 designed to transmit, as the vehicle travels, a pulling or pushing force between the two units which allows the movement of the above-mentioned units, is made from composite material reinforced with fibre.

Preferably, the connecting means 3 are at least in part made from composite material reinforced with long fibres.

Alternatively, the connecting means 3 are at least in part made from composite material reinforced with short fibres.

Still more preferably, the composite material reinforced with fibres comprises carbon fibre, that is to say, it consists of a composite material with carbon fibres.

It should be noted that the composite material with carbon fibres is a High Module material (HM). Alternatively, the composite material with fibres of carbon is a High Strength material (HS).

Preferably, the composite material reinforced with fibre comprises a polymer (plastic) material (matrix).

The polymer material may be thermoplastic or thermosetting.

It should be noted that, advantageously, the connecting device 1 made from composite material reinforced with fibre is a particularly lightweight device, which advantageously allows the useful life of the vehicle to which it is applied to be extended and also allows the energy consumption of the vehicle to be reduced.

It should also be noted that the driving comfort is increased; in addition, the reliability in terms of safety of the connecting device is particularly high.

According to a preferred embodiment, shown in FIG. 1, the connecting means 3 comprise a first rotary joint 4 having a first portion 5A and a second portion 5B rotating relative to each other with respect to a vertical axis XV to allow the above-mentioned movement (rotation) on the horizontal plane of the first and second unit 2A, 2B.

It should be noted that, preferably, the first portion 5A and second portion 5B are configured to define, together, a bearing.

Again, according to the embodiment of FIG. 1, one of the portions 5B of the first rotary joint 4 is supported by the other of the portions 5A of the first rotary joint 4.

More specifically, according to the embodiment illustrated in FIG. 1, the first portion 5A is connected (fixed) to the frame 7A of the first unit 2A.

According to another aspect, the connecting means 3 comprise a second rotary joint 6 having a first portion 8A and a second portion 8B rotating relative to each other with respect to a horizontal axis XO to allow the above-mentioned movement (rotation) on the vertical plane of the first and second unit 2A, 2B.

It should be noted that, according to the embodiment illustrated in FIG. 1, the second portion 8B of the second rotary joint 6 is connected (fixed) to the frame 7B of the second unit.

However, according to the embodiment shown in FIG. 1, the first portion 8A of the second rotary joint 6 is integral with the second portion 5B of the first rotary joint 4.

According to another aspect, the device 1 comprises at least one shock absorber 91, 92, operatively connected to a frame 7A, 7B of a unit 2A, 2B and to the connecting means 3 and configured to operate on the connecting means 3 following a relative movement of the units 2A, 2B on the horizontal plane.

In use, the shock absorber 91, 92 following a variation in the relative position (inclination) of the first and second units 2A, 2B on the horizontal plane exerts on the connecting means 3 a direct force to bring the two units 2A, 2B substantially parallel on the horizontal plane, that is, to bring the two units to a relative position of alignment along the direction of travel of the vehicle.

In the embodiment illustrated in FIG. 1, each shock absorber is connected on one side to the second portion 5B of the first rotary joint 4 and on the other side to the frame 7A of the first unit 2A.

Preferably, the shock absorber 91, 92 is a hydraulic shock absorber; still more preferably, the shock absorber 91, 92 comprises a piston slidably associated with a cylinder.

One between the piston and the cylinder is connected (directly or indirectly by means of other components) to the frame 7A, 7B of one of the two units 2A, 2B and the other between the piston and the cylinder is connected to the portion 5B of the first rotary joint 4 not connected to the frame 7A, 7B of the one of the two unit 2A, 2B.

More specifically, in more general terms, one between the piston and the cylinder is hinged to the frame 7A, 7B of one of the two units and the other between the piston and cylinder is hinged to the connecting means 3.

Still more in general, the shock absorber 91, 92 is hinged to the frame 7A, 7B of one of the two units (at one end) and it is hinged to the connecting means 3 (at the other end).

Preferably, the device 1 comprises a pair of shock absorbers 91, 92 operatively connected to the frame 7A, 7B of a unit 2A, 2B and to the connecting means 3 in such a way that when one of the shock absorbers 91, 92 is compressed the other of the shock absorbers 91, 92 is in traction.

The two shock absorbers 91, 92 are then preferably positioned, relative to the rotary joint, on opposite sides of the first rotary joint 4.

The shock absorbers 91, 92 are configured to be active following a relative movement of the units 2A, 2B on the horizontal plane.

More specifically, when one 91, 92 of the shock absorbers is compressed, the other 92, 91 of the shock absorbers is extended.

With reference to the embodiment shown in FIG. 1, it should be noted that the first portions 5A, 8A and/or second portions 5B, 8B of the first or second rotary joint 4, 6 are made from the above-mentioned composite material.

FIG. 2 shows another embodiment of the connecting device 1.

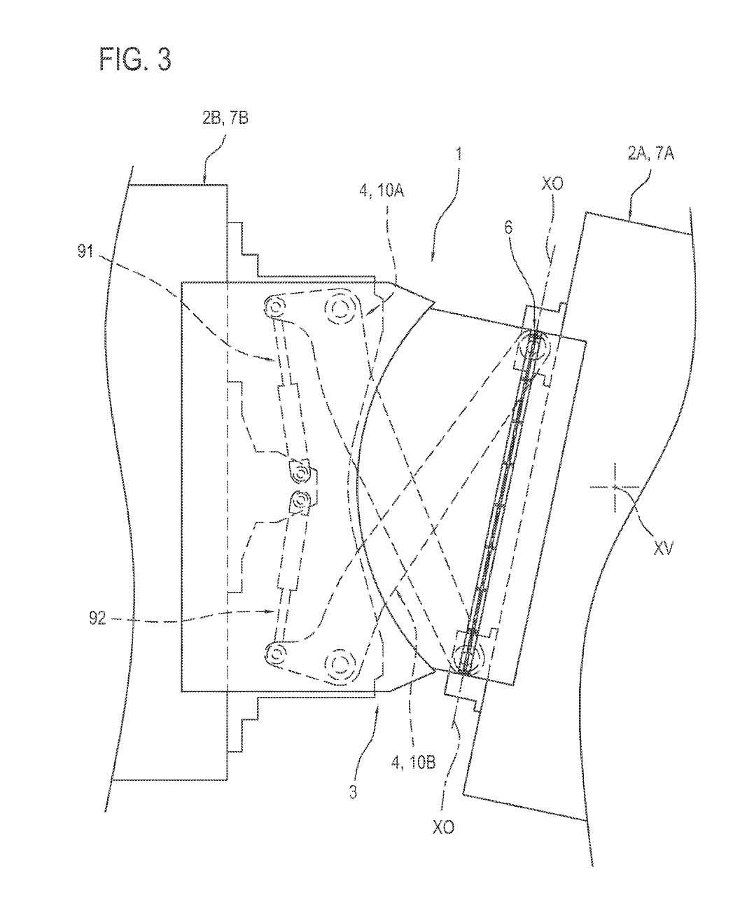

According to an embodiment shown in FIGS. 2 and 3, the first rotary joint 4 comprises a plurality of arms 10A, 10B, each configured for rotating about at least one respective pivot point.

It should be noted that the arms 10A, 10B are made from the above-mentioned composite material (preferably from composite material with carbon fibre).

More specifically, according to the embodiment illustrated in FIG. 2, the device 1 comprises a pair of arms 10A, 10B.

It should be noted that each of the arms 10A, 10B is connected (hinged), at one end to the frame 7B of one of the two units and is connected (indirectly, that is, by means of a rotary joint 6) at the other end to the frame 7A of the other unit.

Preferably, the device 1 comprises shock absorbers 91, 92 connected to the arms 10A, 10B.

More specifically, each of the shock absorbers is connected (hinged) at one end to one of the frames 7A, 7B and at the other end to one of the arms 10A, 10B.

It should be noted that the device 1 also comprises a rotary joint 6, configured to allow a relative movement of the two units on a vertical plane (rotating about a horizontal axis).

The invention defines more generally an articulated vehicle 100, comprising a first unit 2A and a second unit 2B and a device 1 for connecting the first unit 2A and second unit 2B as described above.

Yet more in general, the invention also defines a method for connecting a first unit 2A and a second unit 2B of an articulated vehicle, the method comprising the following steps:

providing means 3 for connecting the first and second unit 2A, 2B and applying the connecting means 3 to the first and second unit 2A, 2B, for allowing a movement on a horizontal plane of the first and second unit 2A, 2B so as to vary the position (angle of inclination) on the horizontal plane between the first and second unit 2A, 2B and to allow a movement on a vertical plane of the first and second unit 2A, 2B so as to vary the position (angle of inclination) on the vertical plane between the first and second unit 2A, 2B; the method comprising a step for making at least a part of the connecting means 3 from composite material.

1. A device for connecting a first unit and a second unit of an articulated vehicle, comprising means for connecting the first and second unit, configured for allowing a movement on a horizontal plane of the first and second unit, for varying the relative position on the horizontal plane between the first and second unit, and configured for following a movement on a vertical plane of the first and second unit, for varying the relative position on the vertical plane between the first and second unit, the device being characterised in that the connecting means are at least in part made from composite material reinforced with fibre.

2. The device according to claim 1, wherein at least a portion of the connecting means designed to transmit, as the vehicle travels, a pulling or pushing force between the two units, is made from composite material reinforced with fibre.

3. The device according to claim 2, wherein the movement on a horizontal plane is a rotation about a vertical axis (XV).

4. The device according to claim 1, wherein the movement on a vertical plane is a rotation about a horizontal axis (XO).

5. The device according to claim 1, wherein the composite material reinforced with fibre comprises carbon fibre.

6. The device according to claim 1, wherein the connecting means comprise a first rotary joint having a first portion and a second portion rotating relative to each other with respect to a vertical axis to allow the above-mentioned movement on the horizontal plane of the first and second unit.

7. The device according to claim 6, wherein the first portion and second portion define, together, a bearing.

8. The device according to claim 6, wherein the first portion of the first rotary joint is supported by the second portion of the first rotary joint.

9. The device according to claim 1, wherein the first rotary joint comprises a plurality of arms, each configured for rotating about at least one respective pivot point.

10. The device according to claim 1, wherein the connecting means comprise a second rotary joint having a first portion and a second portion rotating relative to each other with respect to a horizontal axis to allow the above-mentioned movement on the vertical plane of the first and second unit.

11. The device according to claim 6, wherein the first portions and/or second portions of the first or second rotary joint and/or the arms are made from the above-mentioned composite material reinforced with fibre.

12. The device according to claim 1, further comprising at least one shock absorber, operatively connected to a frame of a unit and to the connecting means and configured to operate on the connecting means following a relative movement of the units on the horizontal plane.

13. The device according to claim 12, comprising a pair of shock absorbers operatively connected to the frame of a unit and to the connecting means in such a way that when one of the shock absorbers is compressed the other of the shock absorbers is in traction, the shock absorbers being configured to operate following a relative movement of the units on the horizontal plane.

14. An articulated vehicle, comprising a first unit and a second unit and a device for connecting the first unit and second unit according to claim 1.

15. A method for connecting a first unit and a second unit of an articulated vehicle, comprising the steps of providing means for connecting the first and second unit and applying the connecting means to the first and second unit, for allowing a movement on a horizontal plane of the first and second unit so as to vary the relative position on the horizontal plane between the first and second unit and to allow a movement on a vertical plane of the first and second unit so as to vary the relative position on the vertical plane between the first and second unit; the method being characterised in that it further comprises a step for making at least a part of the connecting means from composite material reinforced with fibre.
